(19) United States
(12) Patent Application Publication
(10) Pub. No.: US 2007/0076869 A1
(43) Pub. Date: Apr. 5, 2007

(54) Digital goods representation based upon matrix invariants using non-negative matrix factorizations

(75) Inventors: Mehmet Kivanc Mihcak, Redmond, WA (US); Vishal Monga, San Antonio, TX (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/242,632

(22) Filed: Oct. 3, 2005

(51) Int. Cl. G09C 5/00

(52) U.S. Cl. 380/54

(57) ABSTRACT

Described herein is one or more implementations that produce a new representation of a digital good (such as an image) in a new defined representation domain. In particular, the representations in this new domain are based upon matrix invariants. More particularly still, the specific matrix invariants described herein include non-negative matrix factorizations (NMF).

### BACKGROUND

Digital goods are often distributed to consumers over private and public networks—such as Intranets and the Internet. In addition, these goods are distributed to consumers via fixed computer readable media, such as a compact disc (CD-ROM), digital versatile disc (DVD), soft magnetic diskette, or hard magnetic disk (e.g., a preloaded hard drive).

Unfortunately, it is relatively easy for a person to pirate the pristine digital content of a digital good at the expense and harm of the content owners—which includes the content author, publisher, developer, distributor, etc. The content-based industries (e.g., entertainment, music, film, software, etc.) that produce and distribute content are plagued by lost revenues due to digital piracy.

“Digital goods” is a generic label, used herein, for electronically stored or transmitted content. Examples of digital goods include images, audio clips, video, multimedia, software, and data. Depending upon the context, digital goods may also be called a “digital signal,” “content signal,” “digital bitstream,” “media signal,” “digital object,” “object,” “signal,” and the like.

In addition, digital goods are often stored in massive databases—either structured or unstructured. As these databases grow, the need for streamlined categorization and identification of goods increases.

Hashing

Hashing techniques are employed for many purposes. Among those purposes are protecting the rights of content owners and speeding database searching/access. Hashing techniques are used in many areas such as database management, querying, cryptography, and many other fields involving large amounts of raw data.

In general, a hashing technique maps a large block of raw data into a relatively small and structured set of identifiers. These identifiers are also referred to as “hash values” or simply “hash.” By introducing a specific structure and order into raw data, the hashing function drastically reduces the size of the raw data into a smaller (and typically more manageable) representation.

Limitations of Conventional Hashing

Conventional hashing techniques are used for many kinds of data. These techniques have good characteristics and are well understood. Unfortunately, digital goods with visual and/or audio content present a unique set of challenges not experienced in other digital data. This is primarily due to the unique fact that the content of such goods is subject to perceptual evaluation by human observers. Typically, perceptual evaluation is visual and/or auditory.

For example, assume that the content of two digital goods is, in fact, different, but only perceptually, insubstantially so. A human observer may consider the content of two digital goods to be similar. However, even perceptually insubstantial differences in content properties (such as color, pitch, intensity, phase) between two digital goods result in the two goods appearing substantially different in the digital domain.

Thus, when using conventional hash functions, a slightly shifted version of a digital good generates a very different hash value as compared to that of the original digital good, even though the digital good is essentially identical (i.e., perceptually the same) to the human observer.

The human observer is rather tolerant to certain changes in digital goods. For instance, human ears are less sensitive to changes in some ranges of frequency components of an audio signal than other ranges of frequency components.

This human tolerance can be exploited for illegal or unscrupulous purposes. For example, a pirate may use advanced audio processing techniques to remove copyright notices or embedded watermarks from audio signal without perceptually altering the audio quality.

Such malicious changes to the digital goods are referred to as “attacks”, and result in changes at the data domain. Unfortunately, the human observer is unable to perceive these changes, allowing the pirate to successfully distribute unauthorized copies in an unlawful manner.

Although the human observer is tolerant of such minor (i.e., imperceptible) alterations, the digital observer—in the form of a conventional hashing technique—is not tolerant. Traditional hashing techniques are of little help in identifying the common content of an original digital good and a pirated copy of such good because the original and the pirated copy yield very different hash values. This is true even though both are perceptually identical (i.e., appear to be the same to the human observer).

Applications for Hashing Techniques

There are many and varied applications for hashing techniques. Examples of such applications include (but are not limited to) anti-piracy, content categorization, content recognition, watermarking, content-based key generation, and synchronization in audio or video streams.

Hashing techniques may be used to search on the Web for digital goods suspected of having been pirated. In addition, hashing techniques are used to generate keys based upon the content of a signal. These keys are used instead of or in addition to secret keys. Also, hashing functions may be used to synchronize input signals. Examples of such signals include video or multimedia signals. A hashing technique must be fast if synchronization is performed in real time.

### SUMMARY

Described herein is one or more implementations that produce a new representation of a digital good (such as an image) in a new defined representation domain. In particular, the representations in this new domain are based upon matrix invariants. More particularly still, the specific matrix invariants described herein include non-negative matrix factorizations (NMF).

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The same numbers are used throughout the drawings to reference like elements and features.

FIG. 1 is a flow diagram showing a methodological implementation described herein.

FIG. 2 is a block diagram of an implementation described herein.

FIG. 3 is an example of a computing operating environment capable of (wholly or partially) implementing at least one embodiment described herein.

### DETAILED DESCRIPTION

The following description sets forth techniques for that produces a new representation (such as a hash) of a digital good in a new defined representation domain. A digital good (such as a digital image) may be viewed as a matrix. As described herein, a representation of a digital good is generated as a randomized dimensionality reduction that retains the essence of the original digital-good matrix while being secure against intentional attacks of guessing and forgery.

Unlike the conventional approaches, the techniques described herein include digital-goods representation calculations that are based on matrix invariants and more particularly based upon non-negative matrix factorizations (NMF). NMF components capture essential characteristics of digital goods.

However, non-negative matrix factorizations (NMF) approaches have at least two desirable properties for secure robust image hashing applications:

The additivity property resulting from the non-negativity constraints results in bases that capture local components of a digital good (such as an image) that consists of non-negative entries, thereby significantly reducing misclassification.

The effect of geometric attacks on a digital good (such as an image) in the spatial domain manifests (approximately) as independent identically distributed noise on NMF vectors, allowing the design of detectors that are both computationally simple and at the same time optimal in the sense of minimizing error probabilities.

Exemplary Software Activity Status Representation System

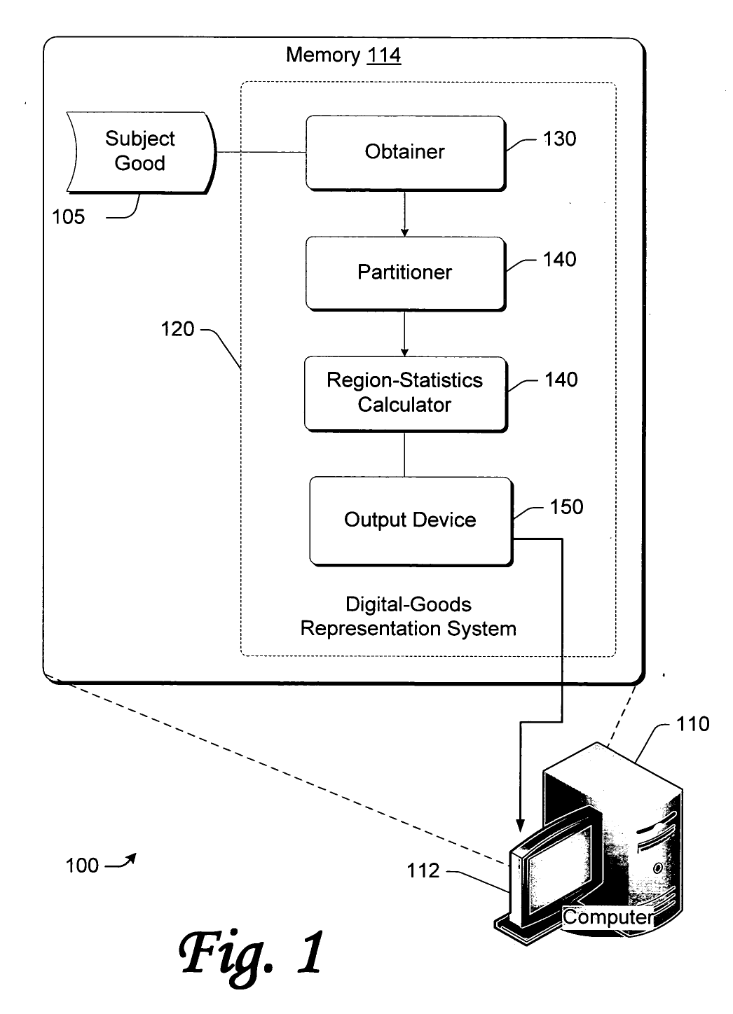

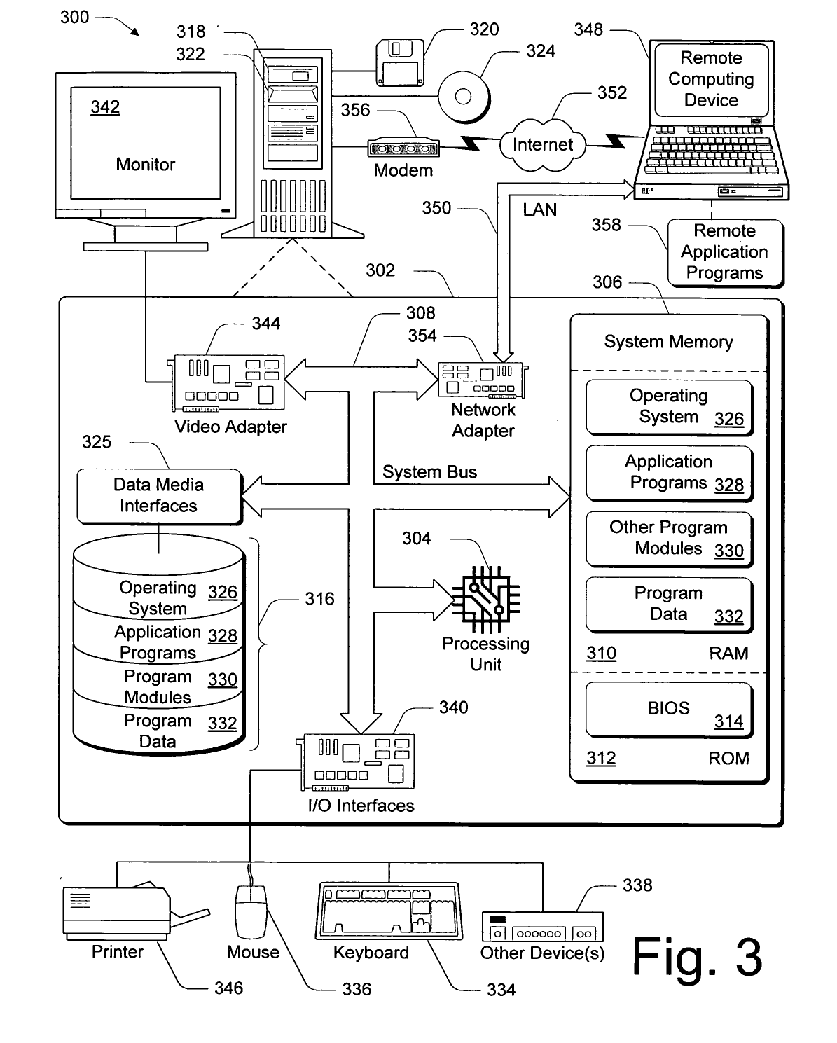

Generally, FIG. 1 illustrates an example of a suitable exemplary computing environment 100 (or configuration) within which an exemplary digital-goods representation system 120, as described herein, may be implemented (either fully or partially). In addition, one or more exemplary embodiments, described herein, may be implemented (wholly or partially) on one or more computing systems and computer networks like the one shown in FIG. 3. Although implementations may have many applications, cryptosystems, authorization, and security are examples of particular applications.

The digital-goods representation system 120 generates a representation (e.g., a hash value) of a digital good, such as subject good 105. In this example, the subject good 105 is a digital image.

As depicted in FIG. 1, this suitable exemplary computing environment 100 includes a computer 110, an output device 112 (e.g., a computer monitor), and a memory 114. The memory 114 may be any available processor-readable media that is accessible by the computer 110. The memory 114 may be either volatile or non-volatile media. In addition, it may be either removable or non-removable media.

FIG. 1 shows the components of the digital-goods representation system 120 running in the memory 114. Those components include a goods obtainer 130, a partitioner 140, a region-statistics calculator 150, and an output production device 160.

As illustrated here, the components of the digital-goods representation system 120 are one or more program modules executing on the computer 110. Of course, this is just one exemplary implementation. With other implementations, the components (independently or collectively) of the system 120 may be implemented in software only, hardware only, firmware only, or a combination thereof.

The goods obtainer 130 obtains a digital good 205 (such as an audio signal or a digital image). It may obtain the goods from nearly any source, such as a storage device or over a network communications link. In addition to obtaining, the goods obtainer 130 may also normalize the amplitude of the goods. In that case, it may also be called an amplitude normalizer.

The partitioner 140 separates the subject good 105 into multiple, pseudo-randomly sized, pseudo-randomly positioned regions (i.e., partitions). Such regions may overlap (but such overlap is not necessary).

For example, if the subject good 105 is an image, it might be partitioned into two-dimensional polygons (e.g., regions) of pseudo-random sizes and locations. In another example, if the subject good 105 is an audio signal, a two-dimensional representation (using frequency and time) of the audio clip might be separated into two-dimensional polygons (e.g., triangles) of pseudo-random size and location.

In this implementation, the regions may indeed overlap with each other.

For each region, the region-statistics calculator 150 calculates statistics of the multiple regions generated by the partitioner 140. Statistics for each region are calculated. The statistics calculated by the calculator 150 may be the feature vectors described below in the description of blocks 230 and 260. With the implementations described herein, the statistics calculated are based upon matrix invariants, in particular non-negative matrix factorizations (NMF).

The output device output production device 160 produces the results (for each region or combined) of the region-statistics calculator 150 for output. These results may be output to the output device 112 (e.g., a computer monitor), may be stored for later use, and/or or used for further calculations.

Non-Negative Matrix Factorization (NMF)

Existing standard-rank reduction techniques—such as the QR decomposition and Singular Value Decomposition (SVD)—produce low rank bases. In some instances, these low rank bases do not respect the structure (i.e., non-negativity for images) of the original data.

Instead of using other existing standard-rank reduction techniques, the digital-goods representation system 120 uses Non-Negative Matrix Factorization (NMF). NMF is a dimensionality reduction technique proposed by this article: D. D. Lee and H. S. Seung, “Algorithms for non-negative matrix factorization,” Advances in Neural Information Processing Systems, 2001.

Non-Negative Matrix Factorization (NMF) is distinguished from traditional matrix approximation approaches by its use of non-negativity constraints. These constraints lead to a parts-based representation because they allow only additive—not subtractive—combinations. This is in contrast to other approaches (such as SVD) which learn holistic and does not include not a parts-based representations.

An immediate consequence of this property with respect to hashing, is far less misclassification (perceptually distinct images mapping to the same hash value) when NMF, as opposed to other approaches, is employed for dimensionality reduction. In addition, it is observed that geometric distortions on digital goods (such as images) result in approximately additive and independent, identically distributed noise on NMF vectors. The digital-goods representation system 120 exploits this property to obtain pseudo-random linear statistics of NMF vectors, which significantly enhances hash robustness while allowing the hash to be of an acceptably small length.

Properties of NMF

The following describes the mathematical properties of NMF. Given a non-negative matrix V of size m×n, an NMF algorithm seeks to find non-negative matrix factors W and H such that
V≈W H, where W ∈ R^{m×r} and H ∈ R^{r×n},

or equivalently, the columns {vⱼ}ⁿⱼ₌ₗ are approximated such that
vⱼ≈W hⱼ, where v^{j} ∈ R^{m} and hⱼ ∈ R^{r}.

For the class of full (non-sparse) matrices, this factorization provides a reduction in storage whenever the number of vectors r, in the basis W is chosen such that.

$$r < \frac{m n}{m + n} .$$

The problem of choosing r for NWF is not as clear as it is with traditional rank reduction techniques. However, the article proposes several formal approaches for choosing a good r: S. M. Wild, “Improving non-negative matrix factorizations through structured initializations,” PhD Thesis, Dept. of Applied Mathematics, University of Colorado at Boulder, 2003. In practice, r is usually chosen such that r <<min(m, n).
Semi-Global Characteristics

The digital-goods representation system 120 derives robust feature vectors of digital goods from pseudo-randomly selected semi-global regions of the goods via matrix invariants. Such regions may (but need not) be overlapping.

Semi-global characteristics are representative of general characteristics of a group or collection of individual elements. As an example, they may be statistics or features of “regions” (i.e., “segments”). Semi-global characteristics are not representatives of the individual local characteristics of the individual elements; rather, they are representatives of the perceptual content of the group (e.g., segments) as a whole.

The semi-global characteristics may be determined by a mathematical or statistical representation of a group. For example, it may be an average of the color values of all pixels in a group. Consequently, such semi-global characteristics may also be called “statistical characteristics.” Local characteristics do not represent robust statistical characteristics.

The digital-goods representation system 120 captures the essence of the geometric information of a digital good while having dimensionality reduction. The essence of the semi-global features and the geometric information of digital goods (such as images) are compactly captured by the significant components of the NMF of such goods. Such components are approximately invariant under intentional or unintentional disturbances as long as the digital goods of interest are not perceptively altered too severely.

With the digital-goods representation system 120, NMF is applied to pseudo-randomly-chosen semi-global regions of images mainly because of security reasons. NMF components obtained from these regions accurately represent the overall features of the digital goods and bear favorable robustness properties while providing reasonable security as long as sufficiently many and large regions are used.

Hashing

A hash function employed by the digital-goods representation system 120 has two inputs, a digital good (such as an image) I and a secret key κ. This hash function produces a short vector ˜h=H_{κ} (I) from a set {0, 1}^{h} with 2^{h} cardinality. It is desirable for the perceptual hash to be equal for all perceptual-similar digital goods with high probability. It is also desirable for two perceptually different digital goods to produce unrelated hash values with high probability. Such a hash function is a many-to-one mapping. On the other hand, for most applications it may be enough to have sufficiently similar (respectively different) hash values for perceptually similar (respectively different) inputs with high probability, i.e., the hash function may show a graceful change.

The requirements for such a hash function are given as:
Randomization: For any given input, its hash value should be approximately uniformly distributed among all possible outputs. The probability measure is defined by the secret key.
Pairwise Independence: The hash outputs for two perceptually different digital goods should be independent with high probability, where the probability space is defined by the secret key.
Invariance: For all possible acceptable disturbances, the output of the hash function should remain approximately invariant with high probability, where the probability space is defined by the secret key.

Two digital goods are deemed to be perceptually similar when there are no reasonably noticeable distortions between them in terms of human perception.

NMF-based Hash Functions

This section discusses several hashing functions that may be employed by the NMF-based transformations (T₁ and T₂) introduced above in the description of FIG. 1.

NMF-NMF Hash Function

Since the resulting hash value is based on a two-stage application of NMF in this described implementation, this hash function is called the NMF-NMF hash function.

Given a digital good (such as an image), for example, the digital-goods representation system 120 pseudo-randomly selects psubimages Aᵢ ∈ R^{m×m}, 1<=i <=p. Then the digital-goods representation system 120 finds a rank r₁ NMF from each sub-image (r₁<<m):
Aᵢ=WᵢFᵢ^{T},

where Wᵢ and Fᵢ are both of size m×r₁. This results in 2p NMF matrices of size m×r₁ each.

Next, the digital-goods representation system 120 pseudo-randomly arranges these matrices to obtain a secondary image J of size m×2pr₁. The system re-applies NMF to obtain a rank r₂ representation of J, r2<<min(m, 2pr₁)
J˜W H,

where W is m×r₂ and H is r₂ ×2pr₁.

The concatenation of columns of W and rows of H gives the hash values.

NMF-NMF-SQ Hash Function

The NMF-NMF-SQ hash function is constructed in this manner:
Obtain the NMF-NMF hash vector h_{K}^{NMF-NMF}(I) as described above in the discussion of the NMF-NMF hash function. Let N be the length of hash vector.
Generate pseudo-random weight vectors {tᵢ}ᵢ₌ₗ^{M} (with M<<N) such that each tᵢ is of length N. The resulting hash vector of length M is given by, <h_{K}^{NMF-NMF}(I), tₗ>, . . . ,<h_{K}^{NMF-NMF}(I), t_{M}>} where <a,b> denotes the inner product (that induces the Euclidean norm) of vectors a and b.

The motivation for the inner product step is to reduce the size of the hash vector. Consider for example, applying the NMF-NMF hashing algorithm to a 256×256 image, with p=10, m=100, r₁=5, and r₂=5. This would result in a hash vector of length 1000. With floating point storage for each entry, such hash lengths may be impractical for some applications.

The design of the weight vectors tᵢ should be done carefully so that the perceptual qualities of the hash are retained. Here, the property that the noise on the NMF-NMF hash vector under attacks is i.i.d, is advantageous. For convenience, one may pick each tᵢ to have i.i.d Gaussian components of zero mean and unit variance. If the noise were to be highly correlated (as is the case with other representations such as wavelets, SVD vectors), the design of the weight vectors would be much more difficult.

Picking weight vectors pseudo-randomly with i.i.d components also enhances the security of the hash. Further, they were chosen to be Gaussian because for a given variance, the Gaussian random variable has the maximum differential entropy.

Thus, with the implementations described herein, one can produce a fixed length hash value regardless of the length of the digital good being input. With conventional approaches, the size of the input directly affects the size of the resulting hash value.

Methodological Implementations of the Exemplary Goods Representer

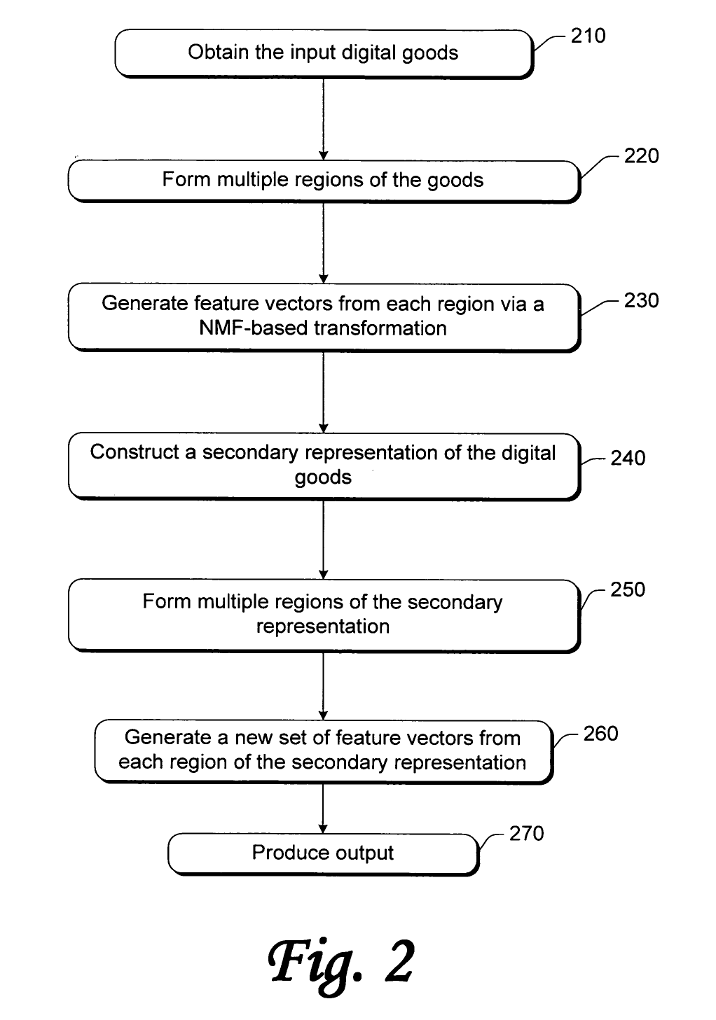

FIG. 2 shows method 200 for generating a representation of a digital good (such as an image) via matrix invariant NMF. This method 200 is performed by one or more of the various components as depicted in FIG. 1. Furthermore, this method 200 may be performed in software, hardware, firmware, or a combination thereof.

For ease of understanding, this method is delineated as separate steps represented as independent blocks in FIG. 2; however, these separately delineated steps should not be construed as necessarily order dependent in their performance. Additionally, for discussion purposes, the method 200 is described with reference to FIG. 1. Also for discussion purposes, particular components are indicated as performing particular functions; however, other components (or combinations of components) may perform the particular functions.

At 210, the digital-goods representation system 120 obtains input digital goods. For this explanation, the input digital goods will be an image of size n×n, which may be described as I ∈ R^{n×n}. Note that, the image may also be rectangular (i.e., the sizes may be different). This approach can be generalized to this condition with no difficulty.

At 220, the digital-goods representation system 120 pseudo-randomly forms multiple regions from I. The number of regions may be called p and the shape of the regions may be, for example, rectangles. The shape of the regions may differ from implementation to implementation.

Although they do not necessarily need to, these regions may possibly overlap with each other. However, one may produce an implementation that requires such overlap. Conversely, one may produce an implementation that does not allow overlap.

The resulting regions are represented by Aᵢ ∈ R^{m×m}, 1<=i <=p. Aᵢ is a matrix which represents the ith pseudo-random region (e.g., a rectangle of size m×m) taken from the digital goods. Note that, each of these regions can be a matrix of different size and this can be easily used in this approach with no difficulty.

At 230, it generates feature vectors (each of which may be labeled ˜gᵢ) from each region Aᵢ via a NMF-based transformation. This feature-vector generation may be generically described as ˜gᵢ=T₁(Aᵢ).

These feature vectors (˜gᵢ) may be used as hash values after suitable quantization or they can be used as intermediate features from which actual hash values may be produced. The NMF-based transformation (T₁(Aᵢ)) is a hash function that employs NMF. Examples of hash functions are described above in the section titled “NMF-based Hash Functions.”

At this point, the digital-goods representation system 120 has produced a representation (the collection of feature vectors produced by ˜gᵢ=T₁(Aᵢ)) of the digital goods. Some implementations may end here with a combination of {˜gₗ, . . . , ˜gₚ} to form the hash vector.

In some implementations, it would be possible to choose p=1 and Aᵢ such that it corresponds to the whole image. Note that this variant does not possess any randomness; hence, it is more suitable for non-adversarial applications of image hashing.

Alternatively, other implementations may perform additional processing to produce even smoother results.

At 240, the digital-goods representation system 120 constructs a secondary representation J of the digital goods by using a pseudo-random combination of feature vectors {˜gₗ, . . . ,˜gₚ}. At this point, these vectors produced as part of block 230 may be considered “intermediate” feature vectors.

As part of such construction of the secondary representation J, the digital-goods representation system 120 applies NMF to each subsection and collects rows and columns of the resulting NMF matrices.

Also note that, instead of this simple pseudo-random re-ordering of vectors, it is possible to apply other (possibly more complex) operations to generate J.

At 250, the digital-goods representation system 120 pseudo-randomly forms multiple regions from J. The number of regions may be called r and the shape of the regions may be, for example, rectangles. The shape of the regions may differ from implementation to implementation. Like the above-described regions, these regions may be any shape and may overlap (but are not required to do so).

This action is represented by this: Bᵢ ∈ R^{d×d}, 1<=i<=r. Bᵢ is a matrix which represents the ith pseudo-random region (e.g., a rectangle of size d×d) taken from the secondary representation J of the digital goods. Note that, in this implementation, the rectangles may have different sizes. In other implementations, the rectangles may be the same size.

At 260, it generates a new set of feature vectors (each of which may be labeled ˜fᵢ) from each region Bᵢ via a NMF-based transformation. This feature-vector generation may be generically described as ˜fᵢ=T₂(Bᵢ).

These feature vectors (˜fᵢ) are hash values. The NMF-based transformation (T₂(Bᵢ)) is a hash function that employs NMF. Examples of hash functions are described above in the section titled “NMF-based Hash Functions.” These two NMF-based transformations (T₁ and T₂) may be the same as or different from each other.

At 270, the digital-goods representation system 120 combines the feature vectors of this new set {˜fₗ, . . . ,˜fₚ} to form the new hash vector, which produces an output that includes the combination of vectors.

Examples of Applications for Exemplary Goods Representer

The digital-goods representation system 120 would be useful for various applications. Such exemplary applications include adversarial and non-adversarial scenarios.

Some exemplary non-adversarial applications include (for purpose of examples only and not limitation) search problems in signal databases, signal monitoring in non-adversarial media. Some exemplary non-adversarial applications include (for purpose of examples only and not limitation) verification applications, such as those which might be used to compactly describe distinguishing features (face pictures, iris pictures, fingerprints, etc.) of human beings.

Exemplary Computing System and Environment

FIG. 3 illustrates an example of a suitable computing environment 300 within which one or more embodiments, as described herein, may be implemented (either fully or partially). The computing environment 300 may be utilized in the computer and network architectures described herein.

The exemplary computing environment 300 is only one example of a computing environment and is not intended to suggest any limitation as to the scope of use or functionality of the computer and network architectures. Neither should the computing environment 300 be interpreted as having any dependency or requirement relating to any one or combination of components illustrated in the exemplary computing environment 300.

One or more embodiments, as described herein, may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

One or more embodiments, as described herein, may be described in the general context of processor-executable instructions, such as program modules, being executed by a computer. Generally, program modules include routines, programs, objects, components, data structures, etc. that perform particular tasks or implement particular abstract data types. One or more embodiments, as described herein, may also be practiced in distributed computing environments where tasks are performed by remote processing devices that are linked through a communications network. In a distributed computing environment, program modules may be located in both local and remote computer storage media including memory storage devices.

The computing environment 300 includes a general-purpose computing device in the form of a computer 302. The components of computer 302 may include, but are not limited to, one or more processors or processing units 304, a system memory 306, and a system bus 308 that couples various system components, including the processor 304, to the system memory 306.

The system bus 308 represents one or more of any of several types of bus structures, including a memory bus or memory controller, a peripheral bus, an accelerated graphics port, and a processor or local bus using any of a variety of bus architectures. By way of example, such architectures can include a CardBus, Personal Computer Memory Card International Association (PCMCIA), Accelerated Graphics Port (AGP), Small Computer System Interface (SCSI), Universal Serial Bus (USB), IEEE 1394, a Video Electronics Standards Association (VESA) local bus, and a Peripheral Component Interconnects (PCI) bus, also known as a Mezzanine bus. Computer 302 typically includes a variety of processor-readable media. Such media may be any available media that is accessible by computer 302 and includes both volatile and non-volatile media, removable and non-removable media.

The system memory 306 includes processor-readable media in the form of volatile memory, such as random access memory (RAM) 310, and/or non-volatile memory, such as read only memory (ROM) 312. A basic input/output system (BIOS) 314, containing the basic routines that help to transfer information between elements within computer 302, such as during start-up, is stored in ROM 312. RAM 310 typically contains data and/or program modules that are immediately accessible to and/or presently operated on by the processing unit 304.

Computer 302 may also include other removable/non-removable, volatile/non-volatile computer storage media. By way of example, FIG. 3 illustrates a hard disk drive 316 for reading from and writing to a non-removable, non-volatile magnetic media (not shown), a magnetic disk drive 318 for reading from and writing to a removable, non-volatile magnetic disk 320 (e.g., a “floppy disk”), and an optical disk drive 322 for reading from and/or writing to a removable, non-volatile optical disk 324 such as a CD-ROM, DVD-ROM, or other optical media. The hard disk drive 316, magnetic disk drive 318, and optical disk drive 322 are each connected to the system bus 308 by one or more data media interfaces 325. Alternatively, the hard disk drive 316, magnetic disk drive 318, and optical disk drive 322 may be connected to the system bus 308 by one or more interfaces (not shown).

The disk drives and their associated processor-readable media provide non-volatile storage of computer readable instructions, data structures, program modules, and other data for computer 302. Although the example illustrates a hard disk 316, a removable magnetic disk 320, and a removable optical disk 324, it is to be appreciated that other types of processor-readable media, which may store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, may also be utilized to implement the exemplary computing system and environment.

Any number of program modules may be stored on the hard disk 316 magnetic disk 320, optical disk 324, ROM 312, and/or RAM 310, including by way of example, an operating system 326, one or more application programs 328, other program modules 330, and program data 332.

A user may enter commands and information into computer 302 via input devices such as a keyboard 334 and a pointing device 336 (e.g., a “mouse”). Other input devices 338 (not shown specifically) may include a microphone, joystick, game pad, satellite dish, serial port, scanner, and/or the like. These and other input devices are connected to the processing unit 304 via input/output interfaces 340 that are coupled to the system bus 308, but may be connected by other interface and bus structures, such as a parallel port, game port, or a universal serial bus (USB).

A monitor 342 or other type of display device may also be connected to the system bus 308 via an interface, such as a video adapter 344. In addition to the monitor 342, other output peripheral devices may include components, such as speakers (not shown) and a printer 346, which may be connected to computer 302 via the input/output interfaces 340.

Computer 302 may operate in a networked environment using logical connections to one or more remote computers, such as a remote computing device 348. By way of example, the remote computing device 348 may be a personal computer, portable computer, a server, a router, a network computer, a peer device or other common network node, and the like. The remote computing device 348 is illustrated as a portable computer that may include many or all of the elements and features described herein, relative to computer 302.

Logical connections between computer 302 and the remote computer 348 are depicted as a local area network (LAN) 350 and a general wide area network (WAN) 352. Such networking environments are commonplace in offices, enterprise-wide computer networks, intranets, and the Internet. Such networking environments may be wired or wireless.

When implemented in a LAN networking environment, the computer 302 is connected to a local network 350 via a network interface or adapter 354. When implemented in a WAN networking environment, the computer 302 typically includes a modem 356 or other means for establishing communications over the wide network 352. The modem 356, which may be internal or external to computer 302, may be connected to the system bus 308 via the input/output interfaces 340 or other appropriate mechanisms. It is to be appreciated that the illustrated network connections are exemplary and that other means of establishing communication link(s) between the computers 302 and 348 may be employed.

In a networked environment, such as that illustrated with computing environment 300, program modules depicted relative to the computer 302, or portions thereof, may be stored in a remote memory storage device. By way of example, remote application programs 358 reside on a memory device of remote computer 348. For purposes of illustration, application programs and other executable program components, such as the operating system, are illustrated herein as discrete blocks, although it is recognized that such programs and components reside at various times in different storage components of the computing device 302, and are executed by the data processor(s) of the computer.

Processor-Executable Instructions

One or more embodiments, as described herein, may be described in the general context of processor-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 3 illustrates an example of a suitable operating environment 300 in which one or more embodiments, as described herein, may be implemented. Specifically, the digital-goods representation system 120 described herein may be implemented (wholly or in part) by any program modules 328-330 and/or operating system 326 in FIG. 3 or a portion thereof.

The operating environment is only an example of a suitable operating environment and is not intended to suggest any limitation as to the scope or use of functionality of the digital-goods representation system 120 described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

Processor-Readable Media

One or more embodiments, as described herein, may be stored on or transmitted across some form of processor-readable media. Processor-readable media may be any available media that may be accessed by a computer. By way of example, processor-readable media may comprise, but is not limited to, “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies processor-readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, communication media may comprise, but is not limited to, wired media such as a wired network or direct-wired connection, and wireless media such as acoustic, RF, infrared, and other wireless media. Combinations of any of the above are also included within the scope of processor-readable media.

### CONCLUSION

When randomization is mentioned herein, it should be understood that the randomization is carried out by one or more implementations employing a pseudo-random number generator (e.g., RC4) whose seed is the secret key (κ), where this key is unknown to the adversary.

The techniques, described herein, may be implemented in many ways, including (but not limited to) program modules, general- and special-purpose computing systems, network servers and equipment, dedicated electronics and hardware, firmware, as part of one or more computer networks, and/or a combination thereof.

Although the one or more above-described implementations have been described in language specific to structural features and/or methodological steps, it is to be understood that other implementations may be practiced without the specific exemplary features or steps described herein. Rather, the specific exemplary features and steps are disclosed as preferred forms of one or more implementations. In some instances, well-known features may have been omitted or simplified to clarify the description of the exemplary implementations. Furthermore, for ease of understanding, certain method steps are delineated as separate steps; however, these separately delineated steps should not be construed as necessarily order dependent in their performance.

1. A processor-readable medium having processor-executable instructions that, when executed by a processor, performs a method comprised of representing digital goods in a defined representation domain, wherein such representation is based upon matrix invariants, wherein the matrix invariants include non-negative matrix factorizations (NMF).

2. A medium as recited in claim 1, wherein the method further comprises extracting robust pseudo-random features of the digital goods, wherein the features are within the defined representation domain.

3. A medium as recited in claim 1, wherein the digital goods is selected from a group consisting of a digital image, a digital audio clip, a digital video, a database, and a software image.

4. A computing device comprising:
an audio/visual output;
a medium as recited in claim 1.

5. A processor-readable medium having processor-executable instructions that, when executed by a processor, performs a method facilitating protection of digital goods, the method comprising:
obtaining a digital good;
partitioning the good into a plurality of regions;
calculating statistics of one or more of the regions of the plurality, so that the statistics of a region are representative of it, wherein the statistics calculated are based upon matrix invariants, wherein the matrix invariants include non-negative matrix factorizations (NMF).

6. A medium as recited in claim 5, wherein at least some of the plurality of regions overlap.

7. A medium as recited in claim 5, wherein the partitioning comprises pseudo-randomly segmenting the good into a plurality of regions.

8. A medium as recited in claim 5, wherein the digital goods is selected from a group consisting of a digital image, a digital audio clip, a digital video, a database, and a software image.

9. A medium as recited in claim 5, wherein the method further comprises producing output comprising the calculated statistics of one or more regions.

10. A modulated signal generated by a medium as recited in claim 9.

11. A computer comprising one or more processor-readable media as recited in claim 5.

12. A method comprising:
obtaining a digital good;
partitioning the good into a plurality of regions;
extracting robust features from the plurality of regions, wherein the features are based upon matrix invariant non-negative matrix factorizations (NMF).

13. A method as recited in claim 12, wherein the extracting act is characterized by calculating statistics of one or more of the regions of the plurality, so that the statistics of a region are representative of it, wherein the statistics calculated are based upon the matrix invariant NMF.

14. A method as recited in claim 12, wherein at least some of the plurality of regions overlap.

15. A method as recited in claim 12, wherein the partitioning comprises pseudo-randomly segmenting the good into a plurality of regions.

16. A method as recited in claim 12, wherein the digital goods is selected from a group consisting of a digital image, a digital audio clip, a digital video, a database, and a software image.

17. A method as recited in claim 12, wherein the method further comprises producing output comprising the robust features of one or more regions.
